(19) United States
(12) Patent Application Publication
(10) Pub. No.: US 2007/0181271 A1
(43) Pub. Date: Aug. 9, 2007

(54) INFLATABLE TEMPORARY DOOR

(76) Inventor: Todd EARNEST, Wapello, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/307,403

(22) Filed: Feb. 6, 2006

(51) Int. Cl. E06B 9/00

(52) U.S. Cl. 160/368.1

(57) ABSTRACT

An inflatable temporary door for sealing the opening of a door frame. The inflatable door has a plurality of openings therein such that power cords, vacuum hoses, or the like are disposed through the inflatable door for use on the opposite side of the door frame. Additionally, the inflatable door has a C-shaped opening so that a person may enter or exit the door without removing the inflatable door. The inflatable door also has a plurality of straps that releasably attach to a bracket that is frictionally engaged to a doorframe to secure he inflatable door within the doorframe.

### BACKGROUND OF THE INVENTION

This invention relates to an inflatable temporary door that is placed in a door frame when a doorway is being used to run electrical wires or hoses therethrough. Specifically, when workers clean ducts or do other work that requires heavy duty electrical outlets provided by an outside source the wires and hoses are run through the front door or window of a home so that the vacuum for the ducts or other electrical devices may be used indoors. Similarly, during construction projects when power tools are used, power cords are run out of a room for connection to a power source. By running the cords and hoses through the opening of a door or window the door or window is kept open during the time of use. This can be problematic in that during the spring and summer time bugs fly into a home which is undesirable. Additionally, when construction or vacuuming is done during construction dust and debris in a room filters into the rest of a home. Also, when a doorway is open pets are able to run outside and cold air is allowed into a home or building.

To solve this problem, door guards have been used that are placed in the frame of the door in an attempt to block the opening created by the hoses and electrical cords. Other methods of solving this problem include shutting a door as tightly as possible around a wire which causes damage to the wire.

Therefore, an object of the present invention is to provide an apparatus that will seal a doorway during construction.

A further object is to provide an apparatus that provides an access for easily threading wires and cords through a sealed door opening.

These and other objects, features, or advantages of the present invention will become apparent from the specification and claims.

### BRIEF SUMMARY OF THE INVENTION

An inflatable temporary door that is adapted to fit within a door frame to close the opening of a door. The inflatable temporary door has a C-shaped zipper doorway that is opened for an individual to enter and exit out of the door. Additionally, the inflatable temporary door has a plurality of openings disposed therethrough such that electrical wires, cables, or vacuum hoses may be disposed through the door and the opening between the outside and inside is minimized.

### BRIEF DESCRIPTION OF THE DRAWINGS

FIG. 1 is a side plan view of an inflatable temporary door within a door frame;

FIG. 2 is a side plan view of an inflatable temporary door within a door frame; and

FIG. 3 is a perspective view of an L-shaped bracket.

### DETAILED DESCRIPTION OF THE PREFERRED EMBODIMENT

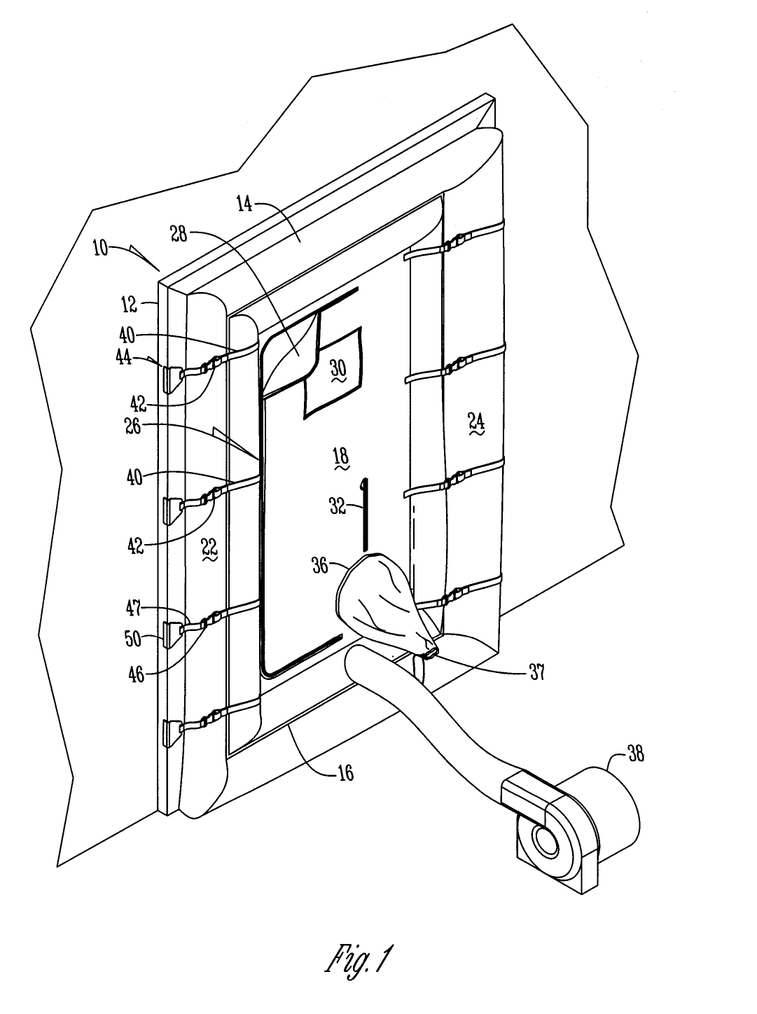

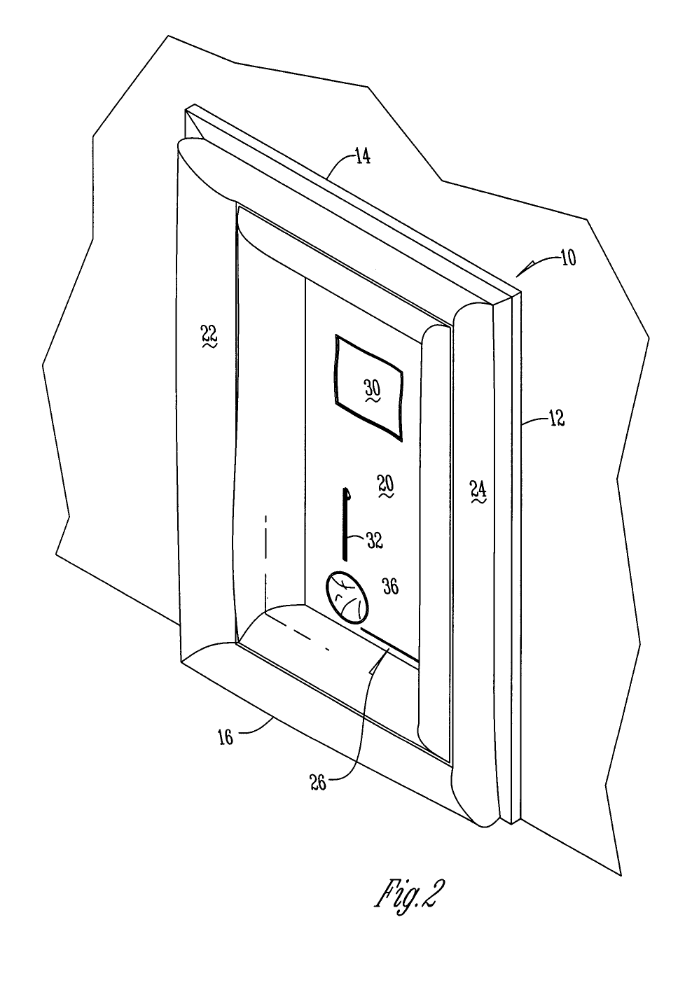

FIG. 1 shows an inflatable temporary door 10 within a door frame 12 of a wall or home. The inflatable temporary door 10 is made of material that will inflate to provide a seal within the door frame 12. In a preferred embodiment the inflatable temporary door, or inflated body 10 is generally rectangularly shaped and has a top 14, bottom 16, front 18, back 20 (FIG. 2), and first and second sides 22, 24.

The inflatable temporary door 10 additionally has an opening or retractable doorway 26 that extends from adjacent the top 14 of the door 10 to adjacent the bottom 16 of the door 10. In a preferred embodiment the doorway 26 is defined by a C-shaped zipper that when unzipped creates a retractable flap 28 that is pulled back to expose the doorway 26. In additional embodiments other types of fastening devices such as a snap fit, Velcro, or the like is used to create the retractable doorway so that an individual can pass through the door frame 12 without deflating the inflatable temporary door 10.

In a preferred embodiment the flap 28 has a square shaped transparent window 30 adjacent the top 14 of the inflatable temporary door 10. The window 30 allows a worker to see activity taking place on the backside of the door 10 before opening the flap 28 and entering a home or office.

In another embodiment the flap 28 has a slot 32 that is disposed therethrough and is retractably opened and closed using a fastening device such as a zipper or the like. The slot 32 allows power cords to be disposed through the inflatable temporary door 10 and the fastening device such as the zipper is fastened minimizing the opening to the outside.

Similarly, in a preferred embodiment the flap 28 has a hose opening 36 that is of size and shape to receive a vacuum hose therethrough so that a vacuum hose may be fed through the inflatable temporary door 10 for vacuuming ducts. In one embodiment the opening 36 is enclosed by a drawstring pouch 37 so that the opening is adjustable to the size of the hose that is disposed therethrough. This again minimizes the flow of air from the outside to the inside of a room home, or office.

An air mover 38 is attached to the inflatable door 10 to provide a constant influx of air into the door to ensure that the door 10 is fully inflated at all times. Thus, the air mover 38 ensures that the tight seal between the inflatable door 10 and the doorframe 12 is continuously maintained.

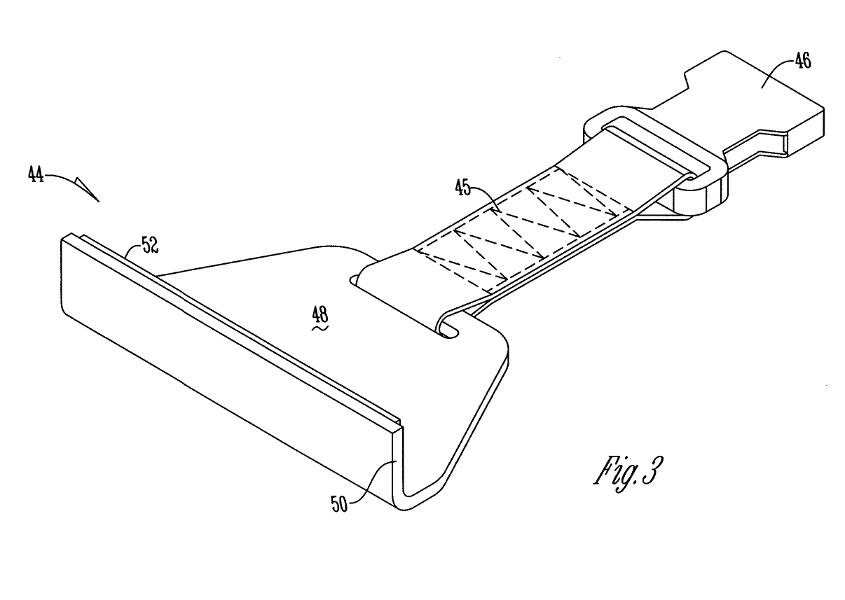

Alternatively, disposed around the perimeter of the doorway 26 are a plurality of straps 40 that have interlocking fastening devices 42 on a first end. The straps 40 detachably engage an L-shaped bracket 44 (FIG. 3) that has a second strap 45 with a second interlocking fastening device 46 at its first end. The second interlocking fastening device detachably engages the first interlocking fastening device to secure the straps 40 of the door 10 to the straps 45 of the L-shaped bracket 44 which secures the door 10 to the L-shaped bracket 44.

The L-shaped bracket has a first surface 48 and a second surface 50 extending in a transverse plane from the first surface 48 to form the L-shape. On the second surface 50 is a flexible elastic material 52 such as rubber or the like that is placed in frictional engagement with the doorframe 12 so that when the second fastening device 46 interlocks with the first interlocking device 42 the L-shaped bracket 44 and holds the inflatable door 10 in place.

In operation, the inflatable temporary door 10 is inflated using the air mover 38 and is placed within a doorframe 12 to seal the opening of a home or room from exterior elements. Using the slot 32, or opening 36, a worker disposes power cords or a hose through the inflatable door and minimizes the amount of air flow between the exterior room or outdoors and an interior room of a home. Thus, at the very least, all of the stated objectives have been met.

It will be appreciated by those skilled in the art that other various modifications could be made to the device without the parting from the spirit in scope of this invention. All such modifications and changes fall within the scope of the claims and are intended to be covered thereby.

What is claimed is:

1. An inflatable temporary door comprising:
an inflated body adapted to fit within a door frame.

2. The inflatable door of claim 1 wherein the inflated body has a retractable doorway disposed therethrough.

3. The inflatable door of claim 2 wherein the doorway comprises a C-shaped zipper that forms a retractable flap.

4. The inflatable door of claim 3 wherein adjacent the C-shaped zipper has at least one strap with a fastening device.

5. The inflatable door of claim 4 further comprising an L-shaped bracket adapted to frictionally engage the doorframe and having a second strap with a second fastening device that releasably engages the first fastening device to hold the inflatable door within the door frame.

6. The inflatable door of claim 1 wherein the door has a slot disposed therethrough for receiving electrical cords.

7. The inflatable door of claim 6 wherein the slot is a retractable zipper.

8. The inflatable door of claim 1 wherein the door has a hose opening.

9. The inflatable door of claim 8 wherein attached to the hose opening is a drawstring pouch.

10. The inflatable door of claim 1 wherein the door has an opening therein for receiving an air mover that supplies air to the door.
